(19) United States
(12) Patent Application Publication
(10) Pub. No.: US 2023/0167266 A1
(43) Pub. Date: Jun. 1, 2023

(54) COMPOSITIONS CONTAINING COLORANTS, PROCESS FOR PREPARING SAID COMPOSITIONS AND THEIR USE

(71) Applicant: Wacker Chemie AG, Munich (DE)

(72) Inventors: Oliver SCHÄFER, Munich (DE); Michael JOACHIMBAUER, Munich (DE)

(73) Assignee: Wacker Chemie AG, Munich (DE)

(21) Appl. No.: 17/923,928

(22) PCT Filed: May 11, 2020
(86) PCT No.: PCT/EP2020/063059

§ 371 Date: Nov. 8, 2022

(51) Int. Cl. C08K 3/22; C08G 77/54; C08K 5/23; C08K 3/04; C08L 83/14

(52) U.S. Cl. CPC C08K 3/22; C08G 77/54; C08K 5/235; C08K 3/04; C08L 83/14; C08K 2003/2241

(57) ABSTRACT

A colorant-containing composition includes (D) at least one colorant, (E) at least one siloxane-polyoxamide copolymer according to the general formula (IV), and optionally (F) additives. A process for producing a colorant-containing composition is also provided.

The present invention relates to colorant-containing compositions, to processes for producing them and to their use in the coloring of polymer materials.

Vital to the individual coloring of plastics articles are what are called color masterbatches, which are currently produced typically from plastics pellets and colorants. The required coloring is accomplished in general through the process of mixing and melting the colorant and plastics pellets, with admixing of small amounts of additives, in the extruder.

The homogeneity of the shade of color in the final plastics article is dependent on the flow behavior achieved in the melt and/or on the quality of distribution of the masterbatch in the matrix. There are therefore specific types of masterbatch for each class of plastic. A fundamental problem in masterbatch production is that pigments, with primary particles lying in the size range from a few nanometers to several micrometers, must be incorporated into the macromolecular materials in the melt-mixing process. The incorporation of the pigment agglomerates and the homogeneous distribution of the pigments in the in some instances very high-viscosity plastics melt, however, may well be problematic. Moreover, in this melt compounding procedure, a polymer material which has already been melted and pelletized has to be melted and pelletized again, possibly a number of times depending on the process. As well as an associated high energy outlay, the repeated thermal loading, as a consequence of chain degradation reactions, may also lead to damage to the masterbatch carrier material, with a resultant reduction in molar mass.

The mixing behavior of colorants in the respective plastics is not predictable, especially at relatively high concentrations of pigments and/or dyes, and so in particular the production of masterbatches often presents difficulties, since the colorants—that is, for example, pigments or dyes—to be incorporated into a particular plastic often undergo agglomeration, causing severe inhomogeneities. This leads to adverse properties on the part of the masterbatch, in terms of rheological or mechanical properties, for example.

EP-A 2113522 discloses a masterbatch comprising a polysiloxane-polyurea copolymer, this being a particularly interesting plastic which, by virtue of its advantageous physical properties, covers a broad field of application and can be incorporated easily and in fine distribution into numerous thermoplastic polymers. It is, furthermore, relatively simple to incorporate color pigments in fine division and high concentration into the reactants used for producing this silicone copolymer. A disadvantage of using color masterbatches according to EP-A 2113522 during the thermoplastic processing of polymers is the fact that the silicone copolymer used in EP-A 2113522 has a propensity toward chain degradation at relatively high processing temperatures, beyond about 220° C., and so it cannot be used with certain thermoplastics having relatively high processing temperature, since, owing to the thermal degradation, the homogeneous delivery of the pigments to the thermoplastic matrix is no longer ensured.

A subject of the invention is a process for producing colorant-containing compositions, wherein

in a 1st step at least one siloxane (A) of the general formula (I)

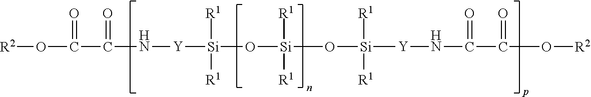

where

R¹ may be identical or different and is a monovalent, SiC-bonded, optionally substituted hydrocarbon radical which may be interrupted by heteroatoms,

R² may be identical or different and is hydrogen atom or a monovalent, optionally substituted hydrocarbon radical, which may be interrupted by heteroatoms,

Y may be identical or different and denotes divalent, optionally substituted hydrocarbon radicals having 1 to 40 carbon atoms, where individual carbon atoms may be replaced by oxygen atoms or —NR—,

R is hydrogen atom or a monovalent, optionally substituted hydrocarbon radical,

n is 0 or a number from 1 to 1000 and

p is 0 or a number from 1 to 10,

at least one compound (B) of the general formula

R⁴NH—R³—NR⁴H (II),

where

R³ is a divalent, optionally substituted hydrocarbon radical having 1 to 40 carbon atoms, where individual carbon atoms may be replaced by oxygen atoms or —NR′—, R′ is hydrogen atom or a monovalent, optionally substituted hydrocarbon radical, and R⁴ may be identical or different and is hydrogen atom or a monovalent, optionally substituted hydrocarbon radical, which may be interrupted by heteroatoms,

(D) at least one colorant,

optionally compound (C) of the general formula

R⁵NH—Y¹—SiR⁶₂—[O—SiR⁶₂]ₘ—O—SiR⁶₂—Y¹—NHR⁵ (III),

where

R⁶ may be identical or different and is a monovalent, SiC-bonded, optionally substituted hydrocarbon radical, which may be interrupted by heteroatoms,

R⁵ may be identical or different and is hydrogen atom or a monovalent, optionally substituted hydrocarbon radical, which may be interrupted by heteroatoms,

Y¹ may be identical or different and denotes divalent, optionally substituted hydrocarbon radicals having 1 to 40 carbon atoms, where individual carbon atoms may be replaced by oxygen atoms or —NR″—,

R″ is hydrogen atom or a monovalent, optionally substituted hydrocarbon radical, and

m is 0 or a number from 1 to 1000,

and

optionally additives (F)

are mixed with one another and allowed to react, and also, optionally, in a 2nd step, the composition obtained in the 1st step is melted and subsequently pelletized.

A further subject of the invention are colorant-containing compositions comprising

(D) at least one colorant,

(E) at least one siloxane-polyoxamide copolymer comprising units of the general formula (IV)

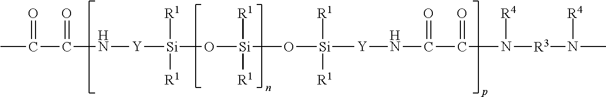

where R¹, R³, R⁴, Y, n and p have the definition indicated for them above in each case, and also

optionally (F) additives.

Preferably n is a number between 20 and 400, more preferably a number between 30 and 250 and very preferably a number between 50 and 200.

Preferably m is a number between 20 and 400, more preferably a number between 30 and 250 and very preferably a number between 50 and 200.

Preferably p is a number from 1 to 3, more preferably 1 or 2, more particularly 1.

Examples of hydrocarbon radicals R¹ are alkyl radicals such as the methyl, ethyl, n-propyl, isopropyl, 1-n-butyl, 2-n-butyl, isobutyl, tert-butyl, n-pentyl, isopentyl, neopentyl, tert-pentyl radical; hexyl radicals such as the n-hexyl radical; heptyl radicals such as the n-heptyl radical; octyl radicals such as the n-octyl radical and isooctyl radicals such as the 2,2,4-trimethylpentyl radical; nonyl radicals such as the n-nonyl radical; decyl radicals such as the n-decyl radical; dodecyl radicals such as the n-dodecyl radical; octadecyl radicals such as the n-octadecyl radical; cycloalkyl radicals such as the cyclopentyl, cyclohexyl, cycloheptyl radical and methylcyclohexyl radicals; alkenyl radicals such as the vinyl, 1-propenyl and the 2-propenyl radical; aryl radicals such as the phenyl, naphthyl, anthryl and penanthryl radical; alkaryl radicals such as o-, m-, p-tolyl radicals; xylyl radicals and ethylphenyl radicals; or aralkyl radicals such as the benzyl radical or the α- and the β-phenylethyl radical.

Preferably radical R¹ comprises aliphatic hydrocarbon radicals, more preferably the methyl or ethyl radical, more particularly the methyl radical.

Examples of radical R² are the radicals indicated for radical R¹.

Preferably radical R² comprises aliphatic hydrocarbon radicals, more preferably the methyl or ethyl radical, more particularly the ethyl radical.

Examples of radical R³ are methylene, ethylene, propylene or hexylene radicals.

Preferably radical R³ comprises divalent aliphatic hydrocarbon radicals, more preferably the ethylene or hexylene radical, more particularly the ethylene radical.

Examples of radical R⁴ are the radicals indicated for radical R¹, or hydrogen atom.

Preferably radical R⁴ comprises hydrogen atom or aliphatic hydrocarbon radicals, more preferably hydrogen atom or the methyl radical, more particularly hydrogen atom.

Examples of radical R⁵ are the radicals indicated for radical R¹.

Preferably radical R⁵ comprises hydrogen atom or aliphatic hydrocarbon radicals, more preferably R⁵ hydrogen atom or the methyl radical, more particularly hydrogen atom.

Examples of radical R⁶ are the radicals indicated for radical R¹.

Preferably radical R⁶ comprises aliphatic hydrocarbon radicals, more preferably the methyl or ethyl radical, more particularly the methyl radical.

Examples of radical R are the radicals indicated for radical R¹, or hydrogen atom.

Preferably radical R, R′ and R″ in each case independently of one another is methyl radical or hydrogen atom, more preferably hydrogen atom.

Examples of radical Y and Y¹ are, independently of one another, methylene, ethylene, propylene and hexylene radicals.

The radicals Y and Y¹ independently of one another are preferably divalent aliphatic hydrocarbon radicals, more preferably the methylene or propylene radical, more particularly the propylene radical.

Component (A) preferably comprises liquids which are colorless at 20° C. and 1013 hPa.

The component (A) used in the invention has a viscosity of preferably between mPas and 30 000 mPas, more preferably between 30 mPas and 2000 mPas, in each case at 25° C.

Examples of the siloxanes (A) used in the process of the invention are those of the formula (I) with

R¹=methyl, R²=H₃C—CH₂—, Y=—(CH₂)₃—, p=1; n=140,

R¹=methyl, R²=H₃C—, Y=—(CH₂)₃—, p=1; n=140,

R¹=methyl, R²=H₃C—, Y=—(CH₂)₃—, p=1; n=50,

R¹=methyl, R²=H₃C—CH₂—, Y=—(CH₂)₃—, p=1; n=50,

R¹=methyl, R²=H₃C—CH₂—, Y=—(CH₂)₃—, p=1; n=140 and

R¹=methyl, R²=H₃C—CH₂—, Y=—(CH₂)₃—, p=1; n=250,

where those of the formula (I) with

R¹=methyl, R²=H₃C—CH₂—, Y=—(CH₂)₃—, p=1; n=140,

R¹=methyl, R²=H₃C—, Y=—(CH₂)₃—, p=1; n=140 or

R¹=methyl, R²=H₃C—CH₂—, Y=—(CH₂)₃—, p=2; n=140

are preferred and that of the formula (I) with

R¹=methyl, R²=H₃C—CH₂—, Y=—(CH₂)₃—, p=1; n=140

is particularly preferred.

Component (A) comprises commercial products or products which may be produced by processes common in silicon chemistry.

The compounds (B) used in the process of the invention are preferably NH₂—(CH₂)₂—NH₂, NH₂—(CH₂)₆—NH₂, H₂N—[(CHCH₃—CH₂—O)₆(C₂H₄—O)₁₂]—(CH₂—CHCH₃)—NH₂, H₂N—[(CHCH₃—CH₂—O)₆(C₂H₄—O)₃₉]—(CH₂—CHCH₃)—NH₂ or H₂N—[(CHCH₃—CH₂—O)₄(C₂H₄—O)₉]—(CH₂—CHCH₃)—NH₂, where NH₂—(CH₂)₂—NH₂ is preferred.

Component (B) comprises commercial products or products which may be produced by processes common in chemistry.

In the process of the invention component (B) is used preferably in amounts of 0.2 to parts by weight, more preferably of 0.4 to 4 parts by weight, based in each case on 100 parts by weight of component (A).

Component (C) preferably comprises liquids which are colorless at 20° C. and 1013 hPa.

The component (C) used optionally in the invention has a viscosity preferably of between 10 mPas and 30 000 mPas, more preferably between 30 mPas and 2000 mPas, in each case at 25° C.

Examples of optionally employed component (C) are

NH₂—(CH₂)₃—SiMe₂—[O—SiMe₂]₂—O—SiMe₂—(CH₂)₃—NH₂,

NH₂—(CH₂)₃—SiMe₂—[O—SiMe₂]₅₀—O—SiMe₂—(CH₂)₃—NH₂,

NH₂—(CH₂)₃—SiMe₂—[O—SiMe₂]₁₄₀—O—SiMe₂—(CH₂)₃—NH₂,

NH₂—(CH₂)₃—SiMe₂—[O—SiMe₂]₂₅₀—O—SiMe₂—(CH₂)₃—NH₂ and

NH₂—(CH₂)—SiMe₂—[O—SiMe₂]₅₀—O—SiMe₂—(CH₂)—NH₂,

where NH₂—(CH₂)₃—SiMe₂—[O—SiMe₂]₅₀—O—SiMe₂—(CH₂)₃—NH₂ or

NH₂—(CH₂)₃—SiMe₂—[O—SiMe₂]₁₄₀—O—SiMe₂—(CH₂)₃—NH₂ are preferred and

NH₂—(CH₂)₃—SiMe₂—[O—SiMe₂]₁₄₀—O—SiMe₂—(CH₂)₃—NH₂ is particularly preferred, where Me stands for the methyl radical.

If component (C) is used in the process of the invention, which is not preferred, the amounts in question are preferably 1 to 50 parts by weight, more preferably 2 to 20 parts by weight, based in each case on 100 parts by weight of component (A).

Component (C) comprises commercial products and products which can be produced by processes common in silicon chemistry.

The colorants (D) used in the invention may be all of the colorants known to date.

By colorants are meant all substances with optical effect. Examples of colorants (D) are the examples stated in DIN ISO 18451.

The colorants (D) are preferably inorganic or organic colorants or precursors thereof, more preferably those selected from inorganic dyes, organic dyes, inorganic pigments and organic pigments, and also their precursors or mixtures thereof.

Examples of inorganic pigments are those from the group of the oxides such as iron oxide (brown, red, black), chromium oxide (green), titanium dioxide or carbon, such as carbon black, or chromates, such as lead chromate yellow, molybdate orange, or complexes of inorganic chromatic pigments, such as chromium titanium yellow, chromium iron brown, cobalt blue, nickel titanium yellow, zinc iron brown, bismuth vanadate yellow, or sulfides, such as cadmium sulfide (yellow, orange, red), cerium sulfide (yellow, orange, red), ultramarine (violet, blue) and zinc sulfide (white).

The organic pigments include azo pigments, such as laked azo pigments (yellow, red), disazo pigments (yellow, orange, red), disazo condensation pigments (yellow, red), benzimidazole pigments (yellow, orange), metal complex pigments (yellow), insoindoline pigments (yellow), insoindolinone pigments (yellow), or else polycyclic pigments, such as quinacridone (violet, blue), quinophthalone (yellow), diketopyrrolopyrrole (orange, red, violet), dioxazine pigments (violet), indanthrone (blue), perylene (red, violet) and phthalocyanine (blue, green).

Examples of dyes are anthraquinone dyes, dioxazine dyes, indigoid dyes, formazan dyes, methine dyes, nitro and nitroso dyes, sulfur dyes, and also metal complex dyes.

The colorants (D) more preferably are inorganic or organic pigments, more particularly inorganic pigments.

In the process of the invention colorants (D) are used preferably in amounts of 2 to 400 parts by weight, more preferably in amounts of 20 to 300 parts by weight, more particularly in amounts of 25 to 200 parts by weight, based in each case on 100 parts by weight of components (A).

If desired, additives (F) may also be used, such as, for example, additives selected from nanofillers, stabilizers, antistats, flame retardants, adhesion promoters, nucleating agents, blowing agents and antibacterial agents.

If additives (F) are used, the amounts involved are preferably 0.1 to 50 parts by weight, more preferably 0.5 to 30 parts by weight, based in each case on 100 parts by weight of component (A). The compositions of the invention preferably contain no additives (F).

The individual constituents of the process of the invention may in each case be one kind of such a constituent or else a mixture of at least two different kinds of such constituents.

In the process of the invention preferably no further constituents beyond components (A), (B), (C), (D) and (F) are used.

Since some of the reactants used may be sensitive to moisture and/or to air, it is advantageous if the 1st step of the process is carried out in the absence of moisture and under protective gas, preferably nitrogen or argon.

In the 1st step of the process of the invention the colorants (D) are mixed preferably into one or more of components (A), (B) or (C), more preferably into component (A).

The homogeneous dispersing of large concentrations of colorants (D) into these relatively low-viscosity systems has the advantage that it is readily manageable and can be accomplished easily by means of the techniques established in the paint and varnish industry.

In the 1st step of the process of the invention preferably a solid-liquid dispersion of the colorants (D) into the components (A), (B) and/or (C) is performed, with optimum incorporation being accomplished for example by milling of the pigments (D).

On the basis of the liquid precursors it is therefore also readily possible to generate pastes having the base shades. These pastes may be mixed to give the final shade preferably before the concluding polymer synthesis in the 1st step. Subsequent full reaction of the components to form the completed colorant-containing composition affords the target product in the desired shading in only one further processing step.

Hence preferably the carrier material of the color masterbatch undergoes thermal loading only one single time before its final deployment. The effect of possible thermal degradation reactions on the matrix is reduced accordingly.

The 1st step of the process of the invention takes place preferably at temperatures of at least 0° C., more preferably at 20 to 250° C. In principle, however, it is also possible to operate at low or higher temperatures.

The 1st step of the invention is carried out preferably under the pressure of the surrounding atmosphere, in other words 900 to 1100 hPa. In principle, however, it is also possible to operate at low or higher pressures.

The compositions obtained in the 1st step are preferably solid at 20° C. and 1013 hPa.

If desired, the composition obtained in the 1st step may be melted in a 2nd step and subsequently pelletized, and this may take place continuously, semibatchwise or batchwise.

The melting in the 2nd step is carried out preferably at temperatures of 50 to 250° C., more preferably of 100 to 200° C., in each case under pressures of preferably 100 to 30 000 hPa, more preferably of 1000 to 15 000 hPa.

The pelletizing in the 2nd step may take place in all existing facilities, such as preferably in strand pelletizing or underwater pelletizing facilities.

The 2nd step pelletizing is carried out preferably at temperatures of 5 to 250° C., more preferably at 10 to 150° C., in each case under pressures of preferably 900 to 1100 hPa.

On conclusion of the 2nd step of the invention, pellets of any desired shape are obtained. The pellets obtained in the invention preferably have a spherical or cylindrical shape with preferably 1 mm to 10 mm side lengths/diameter.

The polysiloxane-polyoxamide copolymers (E) of the compositions of the invention, formed preferably by polycondensation reaction from components (A), (B) and optionally (C) with elimination of low molecular mass components such as alcohols, for example, are preferably alternating block copolymers of the (AB)n type (consisting of at least two block sequences) or of the ABA type (consisting of three blocks). If component (C) is used for producing the copolymers (E), the dispersibility of certain dyes and/or pigments may optionally be optimized by virtue of a modified wetting behavior.

The siloxane structure of component (A) is highly apolar in the copolymer (E). The organic component (B), by contrast, introduces polar groups into the copolymer (E).

Through the variation of apolar and polar units, the polysiloxane copolymers (E) can be adapted to a wide variety of different polymer materials in terms of compatibility.

The consequence is that color masterbatches for virtually all polymer materials can be generated from one or just a few base materials. On the basis of these polysiloxane copolymers (E), accordingly, it is possible to generate universal masterbatches for virtually all polymer materials, but at least groups of polymer materials that are large in each case, such as polyolefins, polyesters, polyamides, styrene-based polymers, etc.

Examples of the units of the formula (IV) in the copolymer (E) are those with

R¹=methyl, R³=—(CH₂)₂—, R⁴=H, Y=—(CH₂)₃—, p=1; n=140,

R¹=methyl, R³=—(CH₂)₆—, R⁴=H, Y=—(CH₂)₃—, p=1; n=140,

R¹=methyl, R³=—(CH₂)₂—, R⁴=H, Y=—(CH₂)₃—, p=1; n=50,

R¹=methyl, R³=—(CH₂)₆—, R⁴=H, Y=—(CH₂)₃—, p=1; n=50,

R¹=methyl, R³=—(CH₂)₆—, R⁴=H, Y=—(CH₂)₃—, p=2; n=140 and

R¹=methyl, R³=—(CH₂)₂—, R⁴=H, Y=—(CH₂)₃—, p=1; n=250,

where those composed of units of the formula (IV) with

R¹=methyl, R³=—(CH₂)₂—, R⁴=H, Y=—(CH₂)₃—, p=1; n=140,

R¹=methyl, R³=—(CH₂)₆—, R⁴=H, Y=—(CH₂)₃—, p=1; n=140 or

R¹=methyl, R³=—(CH₂)₂—, R⁴=H, Y=—(CH₂)₃—, p=1; n=50

are preferred and those composed of units of the formula (IV) with

R¹=methyl, R³=—(CH₂)₂—, R⁴=H, Y=—(CH₂)₃—, p=1; n=140 or

R¹=methyl, R³=—(CH₂)₂—, R⁴=H, Y=—(CH₂)₃—, p=1; n=50

are particularly preferred.

The end groups of the copolymers (E) preferably consist alternatively of unreacted amino end groups of components (B) or (C) or of unreacted oxamido ester groups of component (A), preferred end groups being the unreacted oxamido ester end groups of component (A), since unreacted amino end groups may possibly lead to instances of discoloration at relatively high operating temperatures, with the consequence of the color of the composition of the invention being adversely altered.

Typical examples of copolymers (E) are reaction products of the

siloxanes (A) of the formula (I) used in the process of the invention with R¹=methyl, R²=H₃C—CH₂—, Y=—(CH₂)₃—, p=1; n=140 and compound (B) of the formula (II) with R³=—(CH₂)₂—, R⁴=H or

siloxane (A) of the formula (I) with R¹=methyl, R²=H₃C—CH₂—, Y=—(CH₂)₃—, p=1; n=50 and compound (B) of the formula (II) with R³=—(CH₂)₂—, R⁴=H or

siloxanes (A) of the formula (I) with R¹=methyl, R²=H₃C—CH₂—, Y=—(CH₂)₃—, p=1; n=250 and compound (B) of the formula (II) with R³=—(CH₂)₂—, R⁴=H or

siloxanes (A) of the formula (I) with R¹=methyl, R²=H₃C—CH₂—, Y=—(CH₂)₃—, p=1; n=140 and compound (B) of the formula (II) with R³=—(CH₂)₆—, R⁴=H or

siloxanes (A) of the formula (I) with R¹=methyl, R²=H₃C—CH₂—, Y=—(CH₂)₃—, p=1; n=140 and compound (B) of the formula (II) with R³=—(CH₂)₂—, R⁴=H and compound (C) of the formula (III) with R⁶=methyl, R⁵=H, Y¹=—(CH₂)₃—, m=140 or

siloxanes (A) of the formula (I) with R¹=methyl, R²=H₃C—CH₂—, Y=—(CH₂)₃—, p=1; n=50 and compound (B) of the formula (II) with R³=—(CH₂)₆—, R⁴=H and compound (C) of the formula (III) with R⁶=methyl, R⁵=H, Y¹=—(CH₂)₃—, m=140 or

siloxanes (A) of the formula (I) with R¹=methyl, R²=H₃C—,

Y=—(CH₂)₃—, p=1; n=200 and compound (B) of the formula (II) with R³=—(CH₂)₂—, R⁴=H and compound (C) of the formula (III) with R⁶=methyl, R⁵=H, Y¹=—(CH₂)₃—, m=140 or

siloxanes (A) of the formula (I) with R¹=methyl, R²=H₃C—CH₂—, Y=—(CH₂)₃—, p=1; n=140 and compound (B) of the formula (II) with R³=—(CH₂)₂—, R⁴=H and compound (B) of the formula (II) with R³=—[(CHCH₃—CH₂—O)₆(C₂H₄—O)₁₂]—(CH₂—CHCH₃)—, R⁴=H or siloxanes (A) of the formula (I) with R¹=methyl, R²=H₃C—CH₂—, Y=—(CH₂)₃—, p=1; n=50 and compound (B) of the formula (II) with R³=—(CH₂)₆—, R⁴=H and compound (B) of the formula (II) with R³=—[(CHCH₃—CH₂—O)₆(C₂H₄—O)₃₉]—(CH₂—CHCH₃)—, R⁴=H or siloxanes (A) of the formula (I) with R¹=methyl, R²=H₃C—,

Y=—(CH₂)₃—, p=1; n=200 and compound (B) of the formula (II) with R³=—(CH₂)₂—, R⁴=H and compound (B) of the formula (II) with R³=—[(CHCH₃—CH₂—O)₄(C₂H₄—O)₉]—(CH₂—CHCH₃)—, R⁴=H.

Copolymers (E) in the compositions of the invention possess a molecular weight (number average) of preferably 20 000 g/mol to 1 000 000 g/mol, more preferably 40 000 g/mol to 200 000 g/mol, in each case measured at 45° C. in THF by means of size exclusion chromatography (SEC).

The compositions of the invention are preferably those comprising

(E) copolymers comprising units of the formula (IV),

(D) pigments, and also

optionally (F) additives.

More preferably the compositions of the invention are those comprising

(E) copolymers comprising units of the formula (IV) with R¹=methyl, R³=—(CH₂)₂—, R⁴=H, Y=—(CH₂)₃—, p=1; n=140 and

(D) inorganic pigments from the group of the oxides, or

(E) copolymers comprising units of the formula (IV) with R¹=methyl, R³=—(CH₂)₆—, R⁴=H, Y=—(CH₂)₃— p=1; n=140 and

(D) inorganic pigments from the group of the oxides, or

(E) copolymers comprising units of the formula (IV) with R¹=methyl, R³=—(CH₂)₂—, R⁴=H, Y=—(CH₂)₃—, p=1; n=250 and (D) inorganic pigments from the group of the oxides, or

(E) copolymers comprising units of the formula (IV) with R¹=methyl, R³=—(CH₂)₂—, R⁴=H, Y=—(CH₂)₃—, p=1; n=50 and (D) inorganic pigments from the group of the oxides, or

(E) copolymers comprising units of the formula (IV) with R¹=methyl, R³=—(CH₂)₂—, R⁴=H, Y=—(CH₂)₃—, p=1; n=140 and

(D) organic pigments, or

(E) copolymers comprising units of the formula (IV) with R¹=methyl, R³=—(CH₂)₆—, R⁴=H, Y=—(CH₂)₃—, p=1; n=140 and

(D) organic pigments, or

(E) copolymers comprising units of the formula (IV) with R¹=methyl, R³=—(CH₂)₂—, R⁴=H, Y=—(CH₂)₃—, p=1; n=250 and (D) organic pigments, or

(E) copolymers comprising units of the formula (IV) with R¹=methyl, R³=—(CH₂)₂—, R⁴=H, Y=—(CH₂)₃—, p=1; n=50 and (D) organic pigments, or

(E) copolymers comprising units of the formula (IV) with R¹=methyl, R³=—(CH₂)₂—, R⁴=H, Y=—(CH₂)₃—, p=1; n=140 and

(D) inorganic pigments from the group of the carbon blacks, or

(E) copolymers comprising units of the formula (IV) with R¹=methyl, R³=—(CH₂)₆—, R⁴=H, Y=—(CH₂)₃—, p=1; n=140 and (D) inorganic pigments from the group of the carbon blacks, or

(E) copolymers comprising units of the formula (IV) with R¹=methyl, R³=—(CH₂)₂—, R⁴=H, Y=—(CH₂)₃—, p=1; n=250 and (D) inorganic pigments from the group of the carbon blacks, or

(E) copolymers comprising units of the formula (IV) with R¹=methyl, R³=—(CH₂)₂—, R⁴=H, Y=—(CH₂)₃—, p=1; n=50 and (D) inorganic pigments from the group of the carbon blacks.

Additionally preferred are compositions comprising

(E) copolymers comprising units of the formula (IV) with R¹=methyl, R³=—(CH₂)₂—, R⁴=H, Y=—(CH₂)₃—, p=1; n=140 and

(D) inorganic pigments from the group of the carbon blacks, or

(E) copolymers comprising units of the formula (IV) with R¹=methyl, R³=—(CH₂)₆—, R⁴=H, Y=—(CH₂)₃—, p=1; n=140 and (D) inorganic pigments from the group of the carbon blacks, or

(E) copolymers comprising units of the formula (IV) with R¹=methyl, R³=—(CH₂)₂—, R⁴=H, Y=—(CH₂)₃—, p=1; n=140 and

(D) inorganic pigments from the group of the oxides, or

(E) copolymers comprising units of the formula (IV) with R¹=methyl, R³=—(CH₂)₆—, R⁴=H, Y=—(CH₂)₃—, p=1; n=140 and

(D) inorganic pigments from the group of the oxides, or

(E) copolymers comprising units of the formula (IV) with R¹=methyl, R³=—(CH₂)₂—, R⁴=H, Y=—(CH₂)₃—, p=1; n=140 and

(D) organic pigments, or

(E) copolymers comprising units of the formula (IV) with R¹=methyl, R³=—(CH₂)₆—, R⁴=H, Y=—(CH₂)₃—, p=1; n=140 and (D) organic pigments.

Especially preferred are compositions comprising

(E) copolymers comprising units of the formula (IV) with R¹=methyl, R³=—(CH₂)₂—, R⁴=H, Y=—(CH₂)₃—, p=1; n=140 and

(D) inorganic pigments from the group of the carbon blacks, or

(E) copolymers comprising units of the formula (IV) with R¹=methyl, R³=—(CH₂)₂—, R⁴=H, Y=—(CH₂)₃—, p=1; n=140 and

(D) inorganic pigments from the group of the oxides, or

(E) copolymers comprising units of the formula (IV) with R¹=methyl, R³=—(CH₂)₂—, R⁴=H, Y=—(CH₂)₃—, p=1; n=140 and

(D) organic pigments.

The individual constituents of the compositions of the invention may in each case be one kind of such a constituent or else a mixture of at least two different kinds of such constituents.

The compositions of the invention or produced in accordance with the invention may be employed, then, for all purposes for which colorant-containing compositions have also been employed to date, preferably as a coloring addition in the production of plastics, plastics profiles or plastics fibers.

A further subject of the invention is a process for producing colored shaped articles by mixing a polymer material with the colorant-containing composition of the invention or produced in accordance with the invention, melting and homogenizing the resulting mixture, and subsequently shapingly cooling the mixture.

The process of the invention for producing colored shaped articles may be carried out continuously, semibatchwise or batchwise.

The process of the invention for producing colored shaped articles may take place according to different modes of operation known to date, depending on the polymer materials employed, such as, for example, with the pressures, temperatures and facilities defined for the 2nd step of the process of the invention for producing the compositions of the invention.

Preferred examples of polymer materials used in the invention are polyethylene, polypropylene, polyamide, polyethylene terephthalate, polybutylene terephthalate, thermoplastic elastomers based on crosslinked rubber, ethylene-vinyl acetate, polyhydroxybutyrate and/or copolymers or mixtures thereof, and also polystyrene, impact-modified polystyrene, styrene-acrylonitrile copolymers, acrylonitrile-butadiene-styrene copolymers, polyvinyl chloride, polyvinylidene fluoride, ethylene-tetrafluoroethylene (ETFE), polymethyl methacrylate, polycarbonate, polyaryletherketone, polyacrylonitrile, polyetherimide, polyethylene naphthalate, polyethersulfone, polyimide, polyketone, polyoxymethylene, polyphenylene sulfide, polyphenylene sulfone, polysulfone, styrene-butadiene rubber, acrylonitrile-butadiene rubber, natural rubber, and copolymers or mixtures thereof, particular preference being given to polyethylene, polypropylene, polyamide, polyethylene terephthalate or polybutylene terephthalate.

These polymer materials colored in accordance with the invention may be produced more particularly by mixing at least one polymer material with the composition of the invention or produced in accordance with the invention, in the molten state, and cooling the mixture obtained. The polymer materials colored in the invention take the form preferably of a shaped article, obtainable by a shaping operation selected from the group consisting of injection molding, extrusion, compression molding, roll rotation, rotomolding, laser sintering, fused deposition modeling (FDM), pelletizing and/or casting.

It has proven advantageous in particular that the colorant-containing compositions of the invention or produced in accordance with the invention are very tolerant to a multiplicity of plastics and therefore exhibit high compatibility with a multiplicity of polymer materials or polymer mixtures, in usage concentrations that are customary for the processing and modification of plastics.

The process of the invention has the advantage that it is notable for high efficiency with respect to the process regime.

It has emerged that the color masterbatch of the invention producible according to the process regime of the invention has excellent homogeneity, i.e., no concentration gradient of the colorant in the masterbatch. Further advantageous properties of the color masterbatch include the unusually high thermal stability, outstanding rheological behavior and excellent stress-strain behavior.

The compositions of the invention have the advantage, furthermore, that they are notable for high compatibility with respect to added colorants and the amounts thereof that are used, and exhibit significantly higher thermal stability especially in the relatively high temperature range above 250° C.

A further advantage of the process of the invention is that following the dispersing of the colorants into the fluid polymer precursor, there is further dispersing and homogenizing of the colorants in the fully reacted polymer matrix in the mixer or extruder. This additionally improves the distribution of colorant in the color masterbatch.

The process of the invention has the advantage that the reactants used are highly manageable and can be processed using commonplace apparatus.

The examples described below, unless otherwise indicated, are carried out under a pressure of the surrounding atmosphere, in other words approximately at 1000 hPa, and at room temperature, in other words at about 23° C. or at a temperature which comes about when the reactants are combined at room temperature without additional heating or cooling, and also at a relative atmospheric humidity of about 50%.

Furthermore, all reported parts and percentages are given by weight unless otherwise indicated.

For the purposes of the present invention, the number-average molecular weight Mn is determined by means of size exclusion chromatography (SEC) against polystyrene standard, in THF, at 45° C., flow rate 1.0 ml/min and detection with ELSD (evaporating light-scattering detector) on a triple PLGel MixC column set from Agilent Technologies with an injection volume of 100 μL following acetylation with acetic anhydride.

Silicone 1: Ethyloxalamidopropyl-terminated polydimethylsiloxane of the formula H₅C₂O—CO—CO—NH—C₃H₆—Si(CH₃)₂—[OSi(CH₃)₂]ₙ—OSi(CH₃)₂—C₃H₆—NH—CO—CO—OC₂H₅ having a number-average molecular weight Mn of 11 457 g/mol

Diamine 1: Ethylenediamine NH₂—(CH₂)₂—NH₂

Diamine 2: Aliphatic polyether-diamine having an amine number of 3.3 meq/g (available commercially under the designation “Jeffamine ED 600” from Huntsman, Everberg/BE)

Centrifugal mixer: ARE 250 from C3-Analysentechnik, Haar/DE, manufactured by Thinky Corporation, Tokyo/JP

### Example 1

114.5 g of silicone 1 were weighed out into a 250 ml polypropylene beaker and then 45 g of TiO₂ (available commercially under the designation Kronos 2225 titanium dioxide from Kronos Titan GmbH, Leverkusen, DE) were added as inorganic pigment. This mixture was homogenized for a total of 5 minutes in a centrifugal mixer at a speed of 2000 rpm to give a liquid color paste. Thereafter 0.6 g of diamine 1 was added to the mixture and the mixture was homogenized for a further 120 seconds in the centrifugal mixer at 2000 rpm. After a further 20 minutes of isothermal reaction time without further stirring, the mixture had polymerized. The solid color masterbatch formed was then removed from the PP beaker and cut up into pieces smaller than 5 mm.

### Example 2

114.5 g of silicone 1 were weighed out into a 250 ml polypropylene beaker and then 45 g of pthalocyanine green organic pigment (available commercially under the designation Heliogen® Green from Kremer Pigmente, Aichstetten, DE) were added. This mixture was homogenized for a total of 5 minutes in a centrifugal mixer (ThinkY) at a speed of 2000 rpm. Thereafter 0.6 g of ethylenediamine was added to the mixture and the mixture was homogenized for a further 120 seconds in the centrifugal mixer at 2000 rpm. After a further 20 minutes of isothermal reaction time without further stirring, the mixture had polymerized. The color masterbatch matrix formed was then removed from the PP beaker and cut up into pieces smaller than 5 mm.

### Example 3

114.5 g of silicone 1 were weighed out into a 250 ml polypropylene beaker and then 90 g of TiO₂ (available commercially under the designation Kronos 2225 titanium dioxide from Kronos Titan GmbH, Leverkusen, DE) were added as inorganic pigment. This mixture was homogenized for a total of 5 minutes in a centrifugal mixer (ThinkY) at a speed of 2000 rpm. Thereafter 0.6 g of ethylenediamine was added to the mixture and the mixture was homogenized for a further 120 seconds in the centrifugal mixer at 2000 rpm. After a further 20 minutes of isothermal reaction time without further stirring, the mixture had polymerized. The color masterbatch matrix formed was then removed from the PP beaker and cut up into pieces smaller than 5 mm.

### Example 4

114.5 g of silicone 1 were weighed out into a 250 ml polypropylene beaker and then 45 g of an organic yellow pigment (available commercially under the designation Pigment Yellow 83 from Kremer Pigmente, Aichstetten, DE) were added. This mixture was homogenized for a total of 5 minutes in a centrifugal mixer (ThinkY) at a speed of 2000 rpm. Thereafter 0.6 g of ethylenediamine was added to the mixture and the mixture was homogenized for a further 120 seconds in the centrifugal mixer at 2000 rpm. After a further 20 minutes of isothermal reaction time without further stirring, the mixture had polymerized. The color masterbatch matrix formed was then removed from the PP beaker and cut up into pieces smaller than 5 mm.

### Example 5

114.5 g of silicone 1 were weighed out into a 250 ml polypropylene beaker and then 45 g of pigmentary carbon black (available commercially under the designation Printex 60A from Orion, Frankfurt am Main, DE) were added. This mixture was homogenized for a total of 5 minutes in a centrifugal mixer (ThinkY) at a speed of 2000 rpm. Thereafter 0.6 g of ethylenediamine was added to the mixture and the mixture was homogenized for a further 120 seconds in the centrifugal mixer at 2000 rpm. After a further 20 minutes of isothermal reaction time without further stirring, the mixture had polymerized. The black color masterbatch matrix formed was then removed from the PP beaker and cut up into pieces smaller than 5 mm.

### Example 6

114.5 g of silicone 1 were weighed out into a 250 ml polypropylene beaker and then 45.5 g of pigmentary carbon black (available commercially under the designation Printex 60A from Orion, Frankfurt am Main, DE) were added. This mixture was homogenized for a total of 5 minutes in a centrifugal mixer (ThinkY) at a speed of 2000 rpm.

Subsequently 114.5 g of silicone 1 were weighed out in a second 250 ml PP beaker and thereafter 45.5 g of TiO₂ (available commercially under the designation Kronos 2225 titanium dioxide from Kronos Titan GmbH, Leverkusen, DE) were added. This mixture was likewise homogenized for a total of 5 minutes in a centrifugal mixer (ThinkY) at a speed of 2000 rpm.

Subsequently 80 g of each of these mixtures were placed into a third 250 ml polypropylene beaker, and thereafter 0.6 g of ethylenediamine was added to the mixture and the mixture was homogenized for a further 120 seconds in the centrifugal mixer at 2000 rpm. After a further 20 minutes of isothermal reaction time without further stirring, the mixture had polymerized. The gray color masterbatch matrix formed was then removed from the PP beaker and cut up into pieces smaller than 5 mm.

### Example 7

114.5 g of silicone 1 and 3 g of diamine 2 were weighed out into a 250 ml polypropylene beaker and then 60 g of a blue pigment (available commercially under the designation ultramarine blue, extra-dark from Kremer Pigmente, Aichstetten, DE) were added. This mixture was homogenized for a total of 5 minutes in a centrifugal mixer (ThinkY) at a speed of 2000 rpm. Thereafter 0.3 g of ethylenediamine was added to the mixture and the mixture was homogenized for a further 120 seconds in the centrifugal mixer at 2000 rpm. After a further 20 minutes of isothermal reaction time without further stirring, the mixture had polymerized. The blue color masterbatch matrix formed was then removed from the PP beaker and cut up into pieces smaller than 5 mm.

### Example 8

114.5 g of silicone 1 were weighed out into a 250 ml polypropylene beaker and then 45.5 g of organic yellow pigment (available commercially under the designation Pigment Yellow 83 from Kremer Pigmente, Aichstetten, DE) were added. This mixture was homogenized for a total of 5 minutes in a centrifugal mixer (ThinkY) at a speed of 2000 rpm.

Subsequently 114.5 g of silicone 1 were weighed out in a second 250 ml PP beaker and thereafter 45.5 g of blue pigment (available commercially under the designation ultramarine blue, extra-dark from Kremer Pigmente, Aichstetten, DE) were added. This mixture was likewise homogenized for a total of 5 minutes in a centrifugal mixer (ThinkY) at a speed of 2000 rpm.

Subsequently the two base pastes produced above were placed in a ratio of 120 g of yellow paste to 40 g of blue paste, 80 g of yellow paste to 80 g of blue paste and 40 g of yellow paste to 120 g of blue paste in each case into a separate 250 ml polypropylene beaker, and thereafter in each case 0.6 g of ethylenediamine was added to the mixtures, which were homogenized successively for a further 120 seconds in the centrifugal mixer at 2000 rpm. After a further 20 minutes of isothermal reaction time without further stirring, the mixtures had polymerized. The color masterbatch matrix formed had different green shades depending on the mixing ratio of the base pastes (yellow and blue), and, following removal from the PP beaker, was cut up into pieces smaller than 5 mm.

A free-flowing, tack-free color masterbatch was obtained by subsequent pelletization at 20° C. and 1013 hPa.

### Example 9

2.5 kg of TPU 1 (thermoplastic polyurethane; available commercially under the designation Elastollan® SP 9264 from BASF SE, Ludwigshafen, DE) were mixed with 0.05 kg of color masterbatch from Example 3, in each case in pellet form at room temperature, and the mixture was added via a hopper into zone 1 of a ZK 25 contrarotating twin-screw extruder from Collin (Ebersberg, DE) and compounded. The temperature here in the intake region (zone 1) was 100° C., and was increased to 160° C. in zone 2 and to 165° C. in zone 3. Zone 4 and zone 5 were at 170° C., and the die was heated at 165° C. The rotational speed of the screws was 60 revolutions/minute. The homogeneous melt obtained was extruded continuously from a die having a diameter of 4 mm in the form of an extrudate, which was cooled. This gave 2.5 kg of a homogeneously colored white TPU extrudate having a thickness of 5 mm.

### Example 10

3.5 kg of a thermoplastic copolyamide (copolymer of polyamide 12 and polytetramethylene glycol having a hardness of 81 Shore A, available commercially under the designation PEBAX® 3533 from Arkema SA, Colombes, FR) were mixed with 0.07 kg of a color masterbatch from Example 7, in each case in pellet form, and the mixture was added continuously via a hopper into zone 1 of a ZK 25 contrarotating twin-screw extruder from Collin (Ebersberg, DE) and compounded. The temperature here in the intake region (zone 1) was 100° C., and was increased to 180° C. in zone 2 and to 195° C. in zone 3. Zone 4 and zone 5 were at 190° C., and the die was heated at 190° C. The rotational speed of the screws was 60 revolutions/minute. The homogeneous melt obtained was extruded continuously by means of a die having a diameter of 4 mm in the form of extrudate, which was cooled to 30° C. in a water bath. This gave 3.5 kg of a homogeneously blue-colored thermoplastic polyamide extrudate having a thickness of 5 mm.

### Example 11

3.5 kg of a thermoplastic polyamide 6 (available commercially under the designation Akulon K122 from DMS, Geleen, NL) were mixed with 0.1 kg of a color masterbatch from Example 5, in each case in pellet form, and the mixture was added continuously via a hopper into zone 1 of a 5 contrarotating twin-screw extruder from Collin (Ebersberg, DE) and compounded. The temperature here in the intake region (zone 1) was 140° C., and was increased to 220° C. in zone 2 and to 235° C. in zone 3. Zone 4 and zone 5 were at 230° C., and the die was heated at 220° C. The rotational speed of the screws was 60 revolutions/minute. The homogeneous melt obtained was extruded continuously by means of a die having a diameter of 4 mm in the form of extrudate, which was cooled to 30° C. in a water bath. This gave 3.5 kg of a homogeneously black-colored thermoplastic polyamide extrudate having a thickness of 4.5 mm.

### Example 12

3.5 kg of a thermoplastic polyamide 6 (available commercially under the designation Akulon K122 from DMS, Geleen, NL) were mixed with 0.1 kg of a color masterbatch from Example 5, in each case in pellet form, and the mixture was processed continuously via a hopper on an Engel ES600/125 injection molding machine from Engel (Schwertberg, AT). The temperature here in the intake region (zone 1) was 213° C., and was increased to 220° C. in zone 2 and to 235° C. in zone 3. The die temperature was 235° C., and gate and ejector were heated at 50° C. The internal mold pressure was 370 bar. With a cooling time of 35 sec, test plates were molded cylically, and all had homogeneous black coloration and an elasticity modulus of 2.3 GPa, comparable with a noncolored material.

1-10. (canceled)

11. A colorant-containing composition comprising
(D) at least one colorant,
(E) at least one siloxane-polyoxamide copolymer comprising units of the general formula (IV) 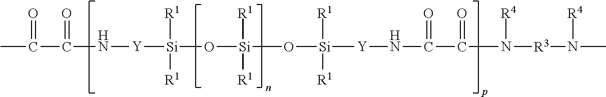
where
R¹ may be identical or different and is a monovalent, SiC-bonded, optionally substituted hydrocarbon radical which may be interrupted by heteroatoms,
Y may be identical or different and denotes divalent, optionally substituted hydrocarbon radicals having 1 to 40 carbon atoms, where individual carbon atoms may be replaced by oxygen atoms or —NR—,
R is hydrogen atom or a monovalent, optionally substituted hydrocarbon radical,
R³ is a divalent, optionally substituted hydrocarbon radical having 1 to 40 carbon atoms, where individual carbon atoms may be replaced by oxygen atoms or —NR′—,
R′ is hydrogen atom or a monovalent, optionally substituted hydrocarbon radical,
R⁴ may be identical or different and is hydrogen atom or a monovalent, optionally substituted hydrocarbon radical, which may be interrupted by heteroatoms,
n is 0 or a number from 1 to 1000 and
p is 0 or a number from 1 to 10,
and also
optionally (F) additives,
produced by a process wherein
in a 1st step at least one siloxane (A) of the general formula (I) 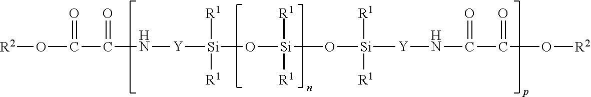
where
R¹ may be identical or different and is a monovalent, SiC-bonded, optionally substituted hydrocarbon radical which may be interrupted by heteroatoms,
R² may be identical or different and is hydrogen atom or a monovalent, optionally substituted hydrocarbon radical, which may be interrupted by heteroatoms,
Y may be identical or different and denotes divalent, optionally substituted hydrocarbon radicals having 1 to 40 carbon atoms, where individual carbon atoms may be replaced by oxygen atoms or —NR—,
R is hydrogen atom or a monovalent, optionally substituted hydrocarbon radical,
n is 0 or a number from 1 to 1000 and
p is 0 or a number from 1 to 10,
at least one compound (B) of the general formula
R⁴NH—R³—NR⁴H (II),
where
R³ is a divalent, optionally substituted hydrocarbon radical having 1 to 40 carbon atoms, where individual carbon atoms may be replaced by oxygen atoms or —NR′—,
R′ is hydrogen atom or a monovalent, optionally substituted hydrocarbon radical, and
R⁴ may be identical or different and is hydrogen atom or a monovalent, optionally substituted hydrocarbon radical, which may be interrupted by heteroatoms,
(D) at least one colorant,
optionally compound (C) of the general formula
R⁵NH—Y¹—SiR⁶₂—[O—SiR⁶₂]ₘ—O—SiR⁶₂—Y¹—NHR⁵ (III),
where
R⁶ may be identical or different and is a monovalent, SiC-bonded, optionally substituted hydrocarbon radical, which may be interrupted by heteroatoms,
R⁵ may be identical or different and is hydrogen atom or a monovalent, optionally substituted hydrocarbon radical, which may be interrupted by heteroatoms,
Y¹ may be identical or different and denotes divalent, optionally substituted hydrocarbon radicals having 1 to 40 carbon atoms, where individual carbon atoms may be replaced by oxygen atoms or —NR″—,
R″ is hydrogen atom or a monovalent, optionally substituted hydrocarbon radical, and
m is 0 or a number from 1 to 1000,
and
optionally additives (F)
are mixed with one another and allowed to react, and also, optionally, in a 2nd step, the composition obtained in the 1st step is melted and subsequently pelletized, where colorants (D) are used in amounts of 2 to 400 parts by weight, based on 100 parts by weight of components (A).

12. The composition as claimed in claim 11, wherein the composition comprises
(E) copolymers comprising units of the formula (IV),
(D) pigments, and also
optionally (F) additives.

13. The composition as claimed in claim 11, wherein the copolymers (E) possess a molecular weight (number average) of 20,000 g/mol to 1,000,000 g/mol, measured at 45° C. in THF by means of Size Exclusion Chromatography (SEC).

14. A process for producing a colorant-containing composition, wherein
in a 1st step at least one siloxane (A) of the general formula (I) 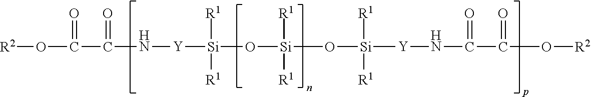
where
R¹ may be identical or different and is a monovalent, SiC-bonded, optionally substituted hydrocarbon radical which may be interrupted by heteroatoms,
R² may be identical or different and is hydrogen atom or a monovalent, optionally substituted hydrocarbon radical, which may be interrupted by heteroatoms,
Y may be identical or different and denotes divalent, optionally substituted hydrocarbon radicals having 1 to 40 carbon atoms, where individual carbon atoms may be replaced by oxygen atoms or —NR—,
R is hydrogen atom or a monovalent, optionally substituted hydrocarbon radical,
n is 0 or a number from 1 to 1000 and
p is 0 or a number from 1 to 10,
at least one compound (B) of the general formula
R⁴NH—R³—NR⁴H (II),
where
R³ is a divalent, optionally substituted hydrocarbon radical having 1 to 40 carbon atoms, where individual carbon atoms may be replaced by oxygen atoms or —NR′—,
R′ is hydrogen atom or a monovalent, optionally substituted hydrocarbon radical, and
R⁴ may be identical or different and is hydrogen atom or a monovalent, optionally substituted hydrocarbon radical, which may be interrupted by heteroatoms,
(D) at least one colorant,
optionally compound (C) of the general formula
R⁵NH—Y¹—SiR⁶₂—[O—SiR⁶₂]ₘ—O—SiR⁶₂—Y¹—NHR⁵ (III),
where
R⁶ may be identical or different and is a monovalent, SiC-bonded, optionally substituted hydrocarbon radical, which may be interrupted by heteroatoms,
R⁵ may be identical or different and is hydrogen atom or a monovalent, optionally substituted hydrocarbon radical, which may be interrupted by heteroatoms,
Y¹ may be identical or different and denotes divalent, optionally substituted hydrocarbon radicals having 1 to 40 carbon atoms, where individual carbon atoms may be replaced by oxygen atoms or —NR″—,
R″ is hydrogen atom or a monovalent, optionally substituted hydrocarbon radical, and
m is 0 or a number from 1 to 1000,
and
optionally additives (F)
are mixed with one another and allowed to react, and also, optionally, in a 2nd step, the composition obtained in the 1st step is melted and subsequently pelletized, where colorants (D) are used in amounts of 2 to 400 parts by weight, based on 100 parts by weight of components (A).

15. The process as claimed in claim 14, wherein the colorant (D) comprises pigments.

16. The process as claimed in claim 14, wherein in the 1st step the colorants (D) are mixed into one or more of components (A), (B) or (C).

17. The process as claimed in claim 14, wherein the melting in the 2nd step is carried out at temperatures of 50 to 250° C. under pressures of 100 to 30 000 hPa.

18. A process for producing colored shaped articles by mixing a polymer material with the colorant-containing composition as claimed in claim 10 that further comprises melting and homogenizing the resulting mixture, and subsequently shapingly cooling the mixture.

19. The process as claimed in claim 18, wherein the polymer materials used are polyethylene, polypropylene, polyamide, polyethylene terephthalate, polybutylene terephthalate, thermoplastic elastomers based on crosslinked rubber, ethylene-vinyl acetate, polyhydroxybutyrate and/or copolymers or mixtures thereof, and also polystyrene, impact-modified polystyrene, styrene-acrylonitrile copolymers, acrylonitrile-butadiene-styrene copolymers, polyvinyl chloride, polyvinylidene fluoride, ethylene-tetrafluoroethylene (ETFE), polymethyl methacrylate, polycarbonate, polyaryletherketone, polyacrylonitrile, polyetherimide, polyethylene naphthalate, polyethersulfone, polyimide, polyketone, polyoxymethylene, polyphenylene sulfide, polyphenylene sulfone, polysulfone, styrene-butadiene rubber, acrylonitrile-butadiene rubber, natural rubber, and copolymers or mixtures thereof.
